(19) United States
(12) Patent Application Publication
(10) Pub. No.: US 2004/0120007 A1
(43) Pub. Date: Jun. 24, 2004

(54) Method and apparatus for forming a display list

(76) Inventors: Dana A. Jacobsen, Boise, ID (US); Terry-Lee M. Fritz, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/325,167

(22) Filed: Dec. 19, 2002

(51) Int. Cl. G06F 15/00

(52) U.S. Cl. 358/1.16; 358/1.12

(57) ABSTRACT

A method for forming a display list for a print job includes storing display list data in memory according to a first data storage method; and switching from the first data storage method to a second data storage method based on one or more predetermined trigger conditions such that a resulting display list is formed using two or more data storage methods.

### BACKGROUND

Computers can be used to generate a wide variety of electronic documents, records, and files. Frequently, the user may desire to have a hardcopy of an electronic document. Consequently, printers have been developed that can receive electronic data from a host computer and produce a hardcopy of the electronic document represented by that data. As used herein, the term “printer” or “printing device” includes any device that produces a hardcopy document from electronic data including, but not limited to, laser printers, ink-jet printers, plotters, facsimile machines, digital copiers, and the like.

Traditional printing operations entail a number of data language conversions. Initially, the data for the electronic document is converted into a page description language (PDL) to aid in the transmission of the image data from the host computer to a printing device. This data is then sent from the host computer to a printing device through an Input/Output (I/O) port of the printing device.

Once the printing device receives the image data, likely written in a PDL, the information is converted to an intermediate form called a display list. A display list is a list of display commands that define graphic elements and their contexts within the image to be printed. These display commands are usually one of the three following types: characters or text, line drawings (also referred to as vectors), and images (also referred to as raster data).

The display list is an intermediate step in the processing of the image data. The display list is then parsed and converted into a final form. This conversion is known as rasterizing the image data. Once rasterized, the image data is sent to the print engine controller for processing and forming of the desired image on a print medium, such as paper.

The time required to process, and the memory used to store, the display list data are important to the performance and cost of the printer. As processing and memory resources are increased to enhance performance, the cost of the printer also increases.

Traditional methods of forming a display list store the display list data as a series of linked “buckets.” Each bucket is a relatively small section of memory that contains a portion of the display list data. When one bucket is filled, another bucket is formed and linked to the first. In this example, the use of buckets allows the display list to grow without needing contiguous segments of memory within a memory unit.

A number of different storage methods may be used to store display list data within a bucket. Each storage method for storing display list data has various trade-offs between the amount of memory space used and the speed with which the storage method may be performed. Traditionally, a single storage method is selected depending on the memory space or operational speed requirements of the printing device. That selected storage method is then used for filling each bucket of display list data.

While the typical printing device uses one data storage method for all buckets, this single selected data storage method may not be the most efficient or optimal data storage method available at any given point in the formation of the series of buckets of display list data. Moreover, under some circumstances, a selected data storage method may become unworkable during the formation of the series of linked buckets due to the complexity or content of the display list.

Consequently, while this method of selecting a single data storage method is usually sufficient to process most display list data while forming a display list, if a change of storage method is required due to data complexity or content, the entire series of linked buckets has to be re-created using the new display list storage method. This re-creation or re-storage of the series of buckets produces an unwanted delay in processing time.

### SUMMARY

In one of various possible embodiments, a method for forming a display list for a print job includes storing display list data in memory according to a first data storage method; and switching from the first data storage method to a second data storage method based on one or more predetermined trigger conditions such that a resulting display list is formed using two or more data storage methods.

Another embodiment of the present invention provides a printing device that includes a processor programmed to select a section of memory for building a display list, store display list data in that section of memory using a first display list storage method, and switch from the first display list storage method to a second display list storage method based on predetermined criteria.

An additional embodiment of the present invention provides a processor readable medium having instructions thereon for storing a first group of data representing a first entry in a print job display list in a first section of memory according to a first storage method, and storing a second group of data representing a second entry in the print job display list in a second section of memory according to a second storage method different from the first storage method.

### BRIEF DESCRIPTION OF THE DRAWINGS

The accompanying drawings illustrate various embodiments of the present invention and are a part of the specification. The illustrated embodiments are merely examples of the present invention and do not limit the scope of the invention.

FIG. 1 is a block diagram illustrating a laser printer according to one embodiment of the present invention.

FIG. 2 is a flowchart illustrating a page history based method for predicting the initial storage method to be used according to one embodiment of the present invention.

FIG. 3 is a flowchart demonstrating a space based display list trigger according to one embodiment of the present invention.

FIG. 4 is a flowchart demonstrating a time based display list trigger according to one embodiment of the present invention.

Throughout the drawings, identical reference numbers designate similar, but not necessarily identical, elements.

### DETAILED DESCRIPTION

A method is described herein that allows for the use of multiple storage methods when forming a series of display list buckets. Consequently, the storage method being used can be changed in response to operational parameters so that a more optimal storage method under any given set of circumstances can be employed, even during the ongoing formation of a display list. In the following text, for purposes of explanation, numerous specific details are set forth in order to provide a thorough understanding of the described embodiments. It will be apparent, however, to one skilled in the art that the embodiments can, in some cases, be practiced without all of these specific details.

Exemplary Structure

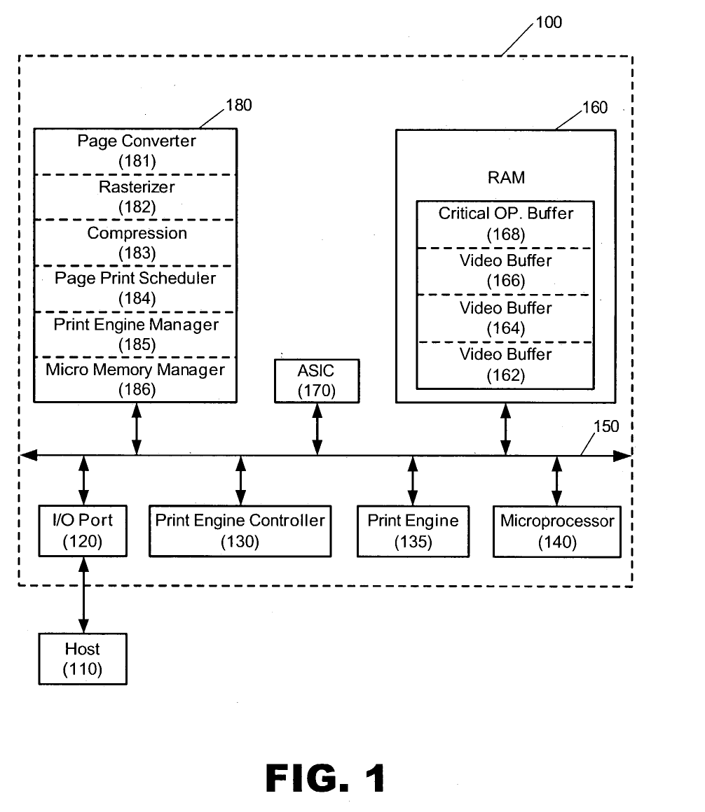

FIG. 1 is a block diagram of a printer (100) incorporating one embodiment of the system and method disclosed herein for efficiently forming a display list of display list data. The printer (100) is controlled by a microprocessor (140) that communicates with the other elements of the system via a bus (150). A print engine controller (130) and associated print engine (135) connect to the bus (150) and provide the print output capability for the printer (100). The print engine (135) is preferably a laser print engine that employs a modulated laser to form images on an imaging drum. However, the principles described herein are similarly applicable to other types of printers and printing devices.

An input/output (I/O) port (120) provides communications between the printer (100) and a host computer (110). The printer (100) receives print jobs, including page descriptions, from the host computer (110) for processing by the printer (100).

A dynamic random access memory (RAM) (160) provides a main memory for the printer (100). RAM (160) is preferably a general-purpose memory and/or a cache memory for use by the processor (140). A first portion of RAM (160) includes, in this example, three pre-allocated or reserved buffers (162, 164, and 166) (hereinafter 162-166), which are employed during print job processing. These buffers may be video buffers or some other type of pre-allocated buffer. During the printing process, each pre-allocated buffer receives rasterized image data for a respective strip of the image being printed. Each buffer (162-166) receives the rasterized image data for storage prior to eventual transmission to the print engine (135).

A second portion of RAM (160) includes another pre-allocated or reserved buffer (168). The pre-allocated buffer (168) is a critical operations buffer and is used for storing critical operation data for the express purpose of reducing printing pauses by the print engine (135) which would potentially otherwise occur due to fragmentation of the general memory area (160) and the general contention for memory resources during the processing of print commands.

Preferably, the critical operations buffer (168) is used to store data that requires a contiguous allocation of memory. For example, data stored in the critical operations buffer (168) may include, selectively, pre-rasterized data, compressed data, pre-rasterized and compressed data, rendered character bitmaps, scaled raster objects, rotated raster objects, vector path data, or other data used for defragmenting memory (160). The critical operations buffer (168) is preferably released for other use after completion of any particular critical operation or at least upon printing of a complete page.

Other portions of RAM (160) are used to store the display list. Because the display list is formed as a series of logically linked buckets, it is unnecessary to have a contiguous memory segment for the display list. This flexibility helps make optimal use of the available RAM resources.

A read only memory (ROM) (180) contains firmware, which controls the operation of the microprocessor (140) and printer (100). Although the firmware routines are described as stored in ROM (180), it is understood that they may be stored in other forms of memory or their functionality may likewise be implemented in an application-specific integrated circuit (ASIC) (170) or other device. The routines (code procedures) stored in ROM (180) include the following: a page converter (181), a rasterizer (182), compression code (183), a page print scheduler (184), and a print engine manager (185).

The page converter firmware (181) converts a page description received from the host computer to a display list. The page converter firmware (181) also divides the page into image strips. The rasterizer firmware (182) converts each display command in the display list to an appropriate rasterized bit map and distributes the bit map into memory (160). The compression firmware (183) compresses the rasterized strips or other data as necessary. ROM (180) further includes a micro memory manager (186) that governs memory management during print job processing.

The page print scheduler (183) controls the sequencing and transferring of image data from the buffers (162-168) to the print engine controller (130). The print engine manager (184) controls the operation of the print engine controller (130) and, in turn, the print engine (135).

Exemplary Implementation and Operation

The operation of the printer (100) shown in FIG. 1 commences when the printer (100) receives a print job or page description from the host computer (110) via the I/O port (120). The page description is placed in RAM (160) and a microprocessor (140) then accesses the description, line by line, and builds a display list using the page converter firmware (181) in ROM (180).

As noted above, a display list is a list of display commands that specify graphic elements and their contexts in an image to be printed. These elements are usually one of the three following types: text/character, line drawings (also referred to as vectors), and images (also referred to as bitmaps or raster data). The display list is an intermediate step in the processing of page information. After the display list is formed, the image data must be rasterized for use by the print engine.

Consequently, any delay in the formation of the display list necessarily delays the output time of the printed page. However, there is also a limitation on the amount of memory that can economically be available in most printing devices. This tension between speed and memory requirements is addressed by varying the data storage methods used to store the display list data.

As described above, display lists are stored as a series of linked “buckets,” where each bucket is a relatively small section of memory containing a portion of the display list data. When a print job is received, typically in a PDL, the microprocessor (140) accesses page converter firmware (181) contained in ROM (180) and converts the page description data received from the host (110) into display list data. The display list data is also partitioned and stored in the series of buckets.

As the microprocessor (140) fills in the buckets with display list data, it links each subsequent bucket to the previous bucket as additional memory is needed and used. In this manner, the display list is allowed to grow without needing physically contiguous sections of memory. The resulting series of linked buckets is then treated logically as a relatively large contiguous section of memory.

When the microprocessor (140) fills the buckets with the display list data, there are a number of different methods that may be utilized to store the data. Some examples of the different methods used to store display list data include word aligned, native structure aligned, byte aligned, bit packed, compressed, and variable length methods, among others. Each method for storing display list data has various trade-offs between the amount of space required and the speed with which the method may be performed.

The relative importance of speed and memory space used varies depending on the display list data to be stored and the amount of memory available for data storage. Several display list data storage methods and their advantages will be described below.

A number of traditional methods for display list data storage focus on performing time-efficient storage of data. The traditional time-efficient methods include, but are not limited to, word aligned, native structure aligned, and byte aligned. According to the word-aligned method, each object is aligned on a word (e.g. 32-bit) boundary. The use of the relatively large word boundary, while not space efficient, greatly increases the processing speed of the display list data storage. The native structure aligned method and the byte aligned method incorporate similar concepts to increase display list processing speed.

Two traditional methods for display list data storage that focus on improving the space efficiency of the data storage include the bit packed method and the compressed data method. According to the bit packed method, a variable number of bits may be used to store each data value. While this method is somewhat slower than many traditional methods, it allows for a minimum number of bits to be used thereby reducing the amount of memory needed to store the data. Similarly, the compressed data method sacrifices processing time to perform data compression in return for increased efficiency in terms of memory space consumed.

An additional method for reducing the space required for display list data storage is variable length coding. Variable length coding takes advantage of the fact that many of the values in display list data are either zero or can be modified via delta coding to be statistically distributed around zero. Variable length codes save storage space by allowing for efficient storage of small numbers. Possible variable length codes include, but are not limited to: Unary codes, modifications of Unary to different bases, Elias Gamma codes, Elias Delta codes, Elias Omega codes, Evan-Rodeh codes, Golumb codes, Rice codes, Golumb codes using Gamma coding for base encoding, Start-Step-Stop codes, Ternary Comma codes, and Fenwick's Punctured codes.

The formation of a series of display list data buckets can be optimized by allowing for the use of different data storage methods throughout the creation of the bucket series. The particular method of data storage used at any given time can then be determined based upon relevant factors such as the availability of memory and processing resources, the complexity of the display list data, etc.

In one embodiment, the display list data is used to create a series of buckets where each bucket can be filled using a different data storage method. Preferably, each bucket in this series includes a description of the data storage method used to fill that bucket.

A number of different methods may be used to indicate which data storage method was used to fill each bucket including, but not limited to, providing an informational header in each bucket. In this case, when the microprocessor (140) accesses the bucket to perform the rasterization process of the display list data, the microprocessor (140) parses and analyzes the header to determine the data storage method used so that the subsequent rasterization process can effectively convert the display list data to rasterized data.

Because different data storage methods may be used to fill each bucket, adjustments may be made to the storage method on a bucket-by-bucket basis. This flexibility allows the microprocessor (140) to optimize the data storage method used, thereby improving printer efficiency. Alternative methods for choosing the data storage method used for any particular bucket are presented below. One or all of the following methods may be implemented in a single embodiment.

Initial Storage Method

The initial storage method used to store each bucket of display list data may be a default method. Alternatively, the initial method may be selected based upon a page history. The term “page history” is to be understood both here and in the appended claims as an evaluation of the resources used to store display list data in the bucket or buckets temporally preceding the current bucket. The page history is established by gathering information regarding the resources used to store the display list data in the previous bucket or buckets. Resource usage factors considered in determining how demanding one or more previous buckets were include, but are not limited to, the storage method used, the amount of memory used on the previous bucket or buckets, the amount of system free memory available, and/or the time required to store the display list data in the previous bucket or buckets.

Based upon the page history, a prediction is made of the probable resource needs of the subsequent bucket or buckets. Using the prediction of the probable resource needs of the next bucket or buckets, an initial display list data storage method is chosen. The page history be established based upon any number of previous buckets for the image being printed.

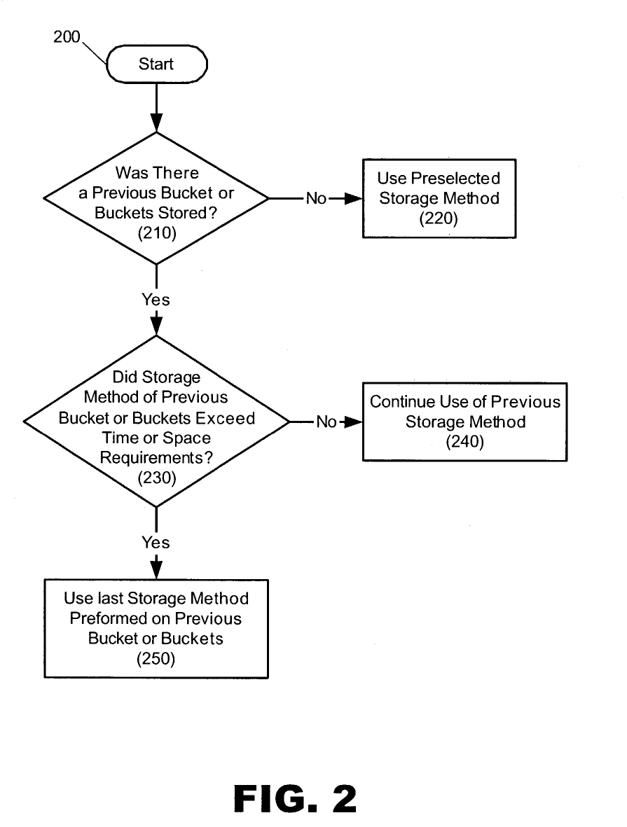

FIG. 2 illustrates one embodiment of a method (200) using a page history to select the initial storage method when creating a series of display list data buckets. This method is preferably conducted by the microprocessor (140; FIG. 1), which is appropriately programmed according to the flowchart of FIG. 2.

Initially the microprocessor determines if there was a previous bucket or buckets formed (determination 210) associated with the current print job. If there was no previous bucket or buckets formed, the microprocessor uses a pre-selected or default storage method that is selected based upon either a processing time or memory space maximization scheme (step 220).

Alternatively, the microprocessor (140; FIG. 1) may analyze the current display list data to make an estimation of the resources required. This estimation can then be used to select the optimal initial data storage method.

If there has been a previous bucket or buckets formed, the microprocessor will determine whether the initial storage method used to store the display list data in the previous bucket or buckets was sufficient to store the display list data directed to that previous bucket or buckets (determination 230). This determination is made by detecting whether the storage method used with the previous bucket or buckets ever exceeded a time or space threshold.

If a threshold condition was exceeded, the system may have switched storage methods and/or the bucket or buckets may have gone through a re-storage process using a different storage method. If such an event occurred, it is recorded in the page history and indicates that a change in the data storage method from the default or initially chosen method had to be made. Consequently, the microprocessor determines the data storage method that was switched to, as opposed to the earlier storage method that failed, and begins to store the current display list data using that most recent data storage method that was used in the previous bucket or buckets in the page history (step 250).

If, however, the initial data storage method used to store display list data in a previous bucket or buckets never exceeded applicable space or time thresholds, the method assumes that the initial data storage method is viable, and the microprocessor may begin storing the display list data associated with the present bucket using that initial data storage method (step 240).

Once the initial data storage method has been selected, it is preferable to monitor the subsequent formation of the series of buckets so that, if necessary, the data storage method can be changed to one that is more optimal under the circumstances, based on the need to trade off memory space versus processing speed. As used herein, and in the appended claims, a “parsimonious” storage method is a storage method that is more space efficient as compared to another storage method, but likely to be slower.

A number of triggers may be defined that will, if they occur, cause an evaluation and/or change in the data storage method being used to fill display list data buckets. A trigger may be chosen based upon the page history. The trigger chosen will indicate certain trigger conditions or values, which when met, cause the microprocessor to employ a different data storage method. Triggers are further discussed below.

The second data storage method that is switched to when a trigger occurs, may also be chosen based on the page history or an evaluation of current operating parameters. The second display list data storage method will be chosen based upon its space/time characteristics being different from those of the first data storage method and more appropriate to current conditions.

The potential switch between different data storage methods may occur on a page-by-page basis during a print job rather than a bucket-by-bucket basis. In some embodiments, the triggers may be turned off or not considered during processing of each page. A single display list data storage method will be chosen for an entire page based on, for example, the page history or an evaluation of the image data to be converted to a display list.

For example, if previous pages were relatively data-poor and did not require a large amount of resources, a time-efficient data storage method will be chosen to store display list data representing an entire page. Trigger criteria are then considered, and appropriate adjustments in data storage method made, between pages of the display list rather than during processing of a particular page.

Space Based Display List Trigger

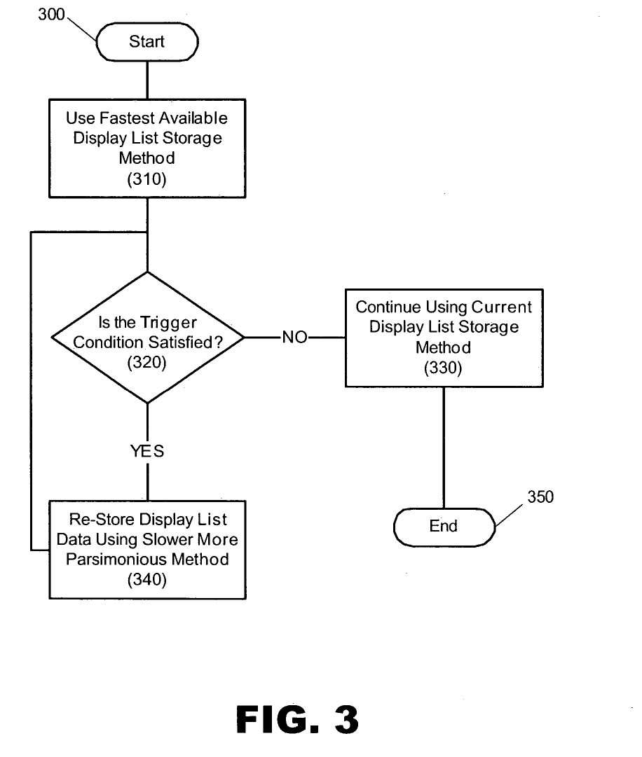

FIG. 3 illustrates an embodiment of a space-based trigger (300) for causing a change in the storage method being used to fill buckets with display list data. As shown in FIG. 3, when using a space-based display list trigger, the fastest available data storage method is preferably used initially (step 310). When certain trigger conditions, described below, are met (determination 320), the microprocessor is triggered to use a different, more space-efficient or parsimonious, data storage method. The bucket may go through a re-storage process that re-stores the display list data in the same bucket using the more space-efficient method (step 340). The re-storage method is also monitored for the above mentioned trigger conditions. If the trigger conditions are again met during the re-storage process, an even more parsimonious method is tried.

Trigger conditions may include, but are not limited to, the amount of free memory being less than a predetermined minimum, the amount of memory fragmentation exceeding a predetermined threshold, the number of display list data buckets in the series exceeding a predetermined threshold, the amount of total intermediate memory exceeding a predetermined threshold, early stages of memory low condition, and/or late stages of memory low condition. If the specified trigger conditions are not met, the microprocessor will continue to store the display list data using the current data storage method (step 330).

In some embodiments, as the microprocessor (140; FIG. 1) is storing display list data in the buckets, the microprocessor is continually monitoring for trigger conditions. When one of the trigger conditions is met, storage of display list data in a current bucket stops and undergoes a re-storage process (step 340) with a different data storage method being used. The re-storage process may be applied to the current bucket or, in some embodiments, the content of all the preceding buckets in the series.

After one change of data storage method occurs, there may still be subsequent changes in the storage method used if the trigger conditions are again met. Any number of storage method changes may occur during the formation of a series of buckets of display list data. Additionally, the trigger conditions may change in response to certain circumstances, such as a predetermined number of preceding changes in the storage method used.

Alternatively, some embodiments may anticipate trigger conditions and change the display list data storage method in anticipation of those trigger conditions during the display list data storage process. According to this alternative embodiment, there is no need to re-store the entire bucket or series using a new data storage method. Rather, once the microprocessor detects that future display list data will not be stored in an optimal manner using the current data storage method, the current data storage method is halted and a different storage method begins where the previous storage method left off. The new data storage method may be used to continue storing the display list data in the same bucket that was started using the previous data storage method. According to this embodiment, a header is inserted in each bucket describing where the data storage method is changed from one storage method to another within the bucket so that the microprocessor may subsequently use the proper rasterization process on all portions of the data.

Time Based Display List Trigger

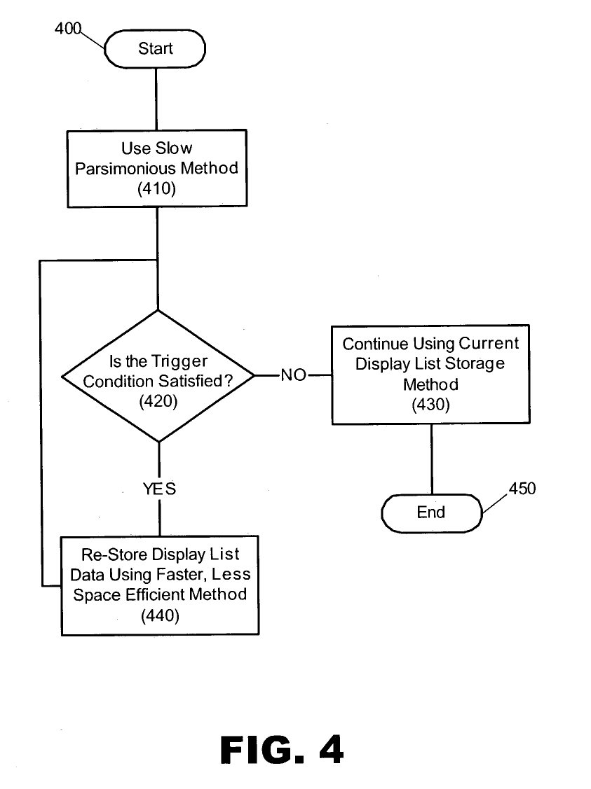

In an alternative embodiment, shown in FIG. 4, a time-based display list trigger is presented. As shown in FIG. 4, the method (400) begins and implements a relatively slow, yet spatially efficient display list data storage method (step 410) to store display list data in the buckets. If certain trigger conditions, described below, are met (determination 420), the microprocessor is triggered to implement a more time-efficient, less parsimonious display list data storage method (step 440). However, if the microprocessor is never triggered to switch the display list data storage method being used, the microprocessor continues to use the initial data storage method (step 430).

The trigger demonstrated in FIG. 4 is a measure of process time, either absolute or relative. An example of a relative trigger may include comparing the time taken to store a quantity of display list data compared to the process time allocated to store an entire page of display list data. If the time taken to store the specified quantity of display list data exceeds the time allocated for that data storage within processing of the entire page, the trigger condition is met (420) and the microprocessor either begins a re-storage process using a more time-efficient display list data storage method (440) or continues to store the display list data from the point the trigger conditions were met, using a more time-efficient display list data storage method.

In an alternative embodiment, an absolute measure of time may be used for the trigger. In this embodiment, a designated process time is set as the trigger condition. As the microprocessor converts a page description into buckets of display list data, the microprocessor also monitors the time required to perform the conversion. If the time exceeds the designated process time, the trigger condition is met (420) and the microprocessor switches a more time-efficient display list data storage process (440), with or without re-storing some or all of the previous buckets.

In conclusion, the use of multiple display list data storage methods when storing display list data in a series of buckets allows for an optimal trade off between memory space and processing speed considerations. Specifically, an automatic change in the display list data storage method used can occur when needed to improve efficiency in either processing time or memory space consumed.

The preceding description has been presented only to illustrate and describe the invention. It is not intended to be exhaustive or to limit the invention to any precise form disclosed. Many modifications and variations are possible in light of the above teaching. It is intended that the scope of the invention be defined by the following claims.

What is claimed is:

1. A method for forming a display list for a print job comprising:
storing display list data in memory according to a first data storage method; and,
switching from the first data storage method to a second data storage method based on one or more predetermined trigger conditions such that a resulting display list is formed using two or more data storage methods.

2. The method of claim 1, wherein storing display list data further comprises repeatedly selecting a section of memory for storage of a portion of the display list data and forming a bucket of display list data in the selected section of memory, wherein succeeding buckets are logically linked together to form a series of buckets of display list data.

3. The method of claim 2, wherein each of the buckets comprises an indication of the data storage method used to store display list data in that bucket.

4. The method of claim 2, further comprising continuing to store display list data in a same bucket after switching to the second data storage method, without re-storing any previously stored display list data.

5. The method of claim 4, further comprising storing in said same bucket an indication of where, within said bucket, switching from the first to second data storage method occurred.

6. The method of claim 2, further comprising re-storing all display list data in a current bucket using the second data storage method after switching to the second data storage method.

7. The method of claim 1, wherein storing display list data in memory according to a first data storage method comprises using a default data storage method to begin storing the display list data.

8. The method of claim 1, wherein storing display list data in memory according to a first data storage method comprises selecting the first data storage method based on a page history.

9. A method for forming a display list for a print job comprising:
storing display list data in memory according to a first data storage method; and,
switching from the first data storage method to a second data storage method based on one or more predetermined trigger conditions such that a resulting display list is formed using two or more data storage methods;
wherein switching from the first data storage method to a second data storage method comprises:
establishing trigger conditions, which, when met, initiate said switching;
evaluating storage of the display list data for existence of the trigger conditions; and
if the trigger conditions are met, switching from the first data storage method to a second data storage method.

10. The method of claim 9, wherein the trigger conditions comprise a processing time parameter.

11. The method of claim 9, wherein the trigger conditions comprise a memory space parameter.

12. The method of claim 1, wherein forming the display list further comprises:
selecting a most space-efficient data storage method as said first data storage method;
establishing a trigger condition comprising a processing time parameter; and
if the trigger condition is met, switching to a second, faster data storage method.

13. The method of claim 12, wherein the second data storage method is selected based on a page history.

14. The method of claim 1, wherein forming the display list further comprises:
selecting a fastest data storage method as said first data storage method;
establishing a trigger condition comprising a memory space parameter; and
if the trigger condition is met, switching to a second, more memory space-efficient data storage method.

15. The method of claim 14, wherein the second data storage method comprises a variable length coding process.

16. The method of claim 1, further comprising multiple trigger conditions and a different data storage method associated with each of the multiple trigger conditions.

17. A method for forming a display list comprising
receiving a page description from a host computing device;
placing the page description in random access memory (RAM);
accessing the page description in RAM to form a display list, wherein forming the display list comprises repeatedly selecting a section of memory in which to store a portion of the display list data, storing a portion of the display list data in the selected section of memory using a first data storage method, and switching from the first data storage method to a second data storage method based on predetermined trigger conditions such that a resulting display list is formed using two or more data storage methods.

18. The method of claim 17, wherein the first or second data storage methods comprises a variable length coding process.

19. The method of claim 17, wherein the storing of the display list data in the section of memory using a first data storage method comprises selecting the first data storage method based on a page history.

20. The method of claim 19, wherein switching from the first data storage method to the second data storage method comprises:
establishing trigger conditions, which, when met, initiate said switching;
evaluating storage of the display list data for existence of the trigger conditions; and
if the trigger conditions are met, switching from the first data storage method to a second data storage method.

21. The method of claim 20, wherein a page-based history is used to select the first data storage method, the trigger conditions, and the second data storage method.

22. The method of claim 19, wherein, if the trigger conditions are met, a remainder of the display list data is stored in the memory using the second data storage method without performing a re-storage process on a portion of the display list information already stored the memory.

23. A printing device configured to form a display list and print a print job based on said display list, the printing device comprising:
a programmed processor; and
a memory to buffer data of the print job while the data is processed prior to printing;
wherein the processor is programmed to store display list data in memory according to a first data storage method, and, during processing of said print job, switch from the first data storage method to a second data storage method based on one or more predetermined trigger conditions such that a resulting display list is formed using two or more data storage methods.

24. A printing device of claim 23, wherein the processor is further programmed to select the first data storage method based on a page history.

25. A printing device of claim 24, wherein the processor is further programmed to:
establish trigger conditions, which, when met, initiate the switch from the first to the second data storage method;
evaluate storage of the display list data for existence of the trigger conditions; and
if the trigger conditions are met, switch from the first data storage method to the second data storage method.

26. A printing device of claim 25, wherein the processor is programmed to use a page history to select the first data storage method, the trigger conditions, and the second data storage method.

27. A processor readable medium having instructions thereon for causing the processor of a printing device to:
store a portion of display list data in a segment of memory according to a first data storage method; and,
if, one or more predetermined trigger conditions are met, store a second portion of display list data according to a second data storage method different from the first data storage method.

28. The medium of claim 27, wherein the first storage method and the second storage method are selected from a group comprising a plurality of data storage methods, where each data storage method of said group varies as to time efficiency or memory space efficiency.

29. The medium of claim 28, wherein said instructions further cause said processor to:
repeatedly store a portion of said display list data in a segment of memory; and
logically link successive segments of memory containing portions of said display list data.

30. The medium of claim 29, wherein said instructions further cause said processor to store an indication of the data storage method used to store display list data in each segment of memory, said indication being stored in a respective segment of memory.

31. The medium of claim 27, wherein said instructions further cause said processor to continue storing display list data in a same memory segment after switching to the second data storage method, without re-storing any previously stored display list data.

32. The medium of claim 31, wherein said instructions further cause said processor to store an indication in the memory segment of where, within the memory segment, switching from the first to second data storage method occurred.

33. The medium of claim 27, wherein said instructions further cause said processor to re-store all display list data in a current memory segment using the second data storage method after switching to the second data storage method.

34. The medium of claim 27, wherein said instructions further cause said processor to use a default data storage method as said first data storage method.

35. The medium of claim 27, wherein said instructions further cause said processor select the first data storage method based on a page history.

36. The medium of claim 27, wherein said instructions further cause said processor to:
establish trigger conditions, which, when met, initiate said switch; and
evaluate storage of the display list data for existence of the trigger conditions.

37. The medium of claim 36, wherein the trigger conditions comprise a processing time parameter.

38. The medium of claim 36, wherein the trigger conditions comprise a memory space parameter.

39. The medium of claim 27, wherein said instructions further cause said processor to:
select a most space-efficient data storage method as said first data storage method; and
establish a trigger condition comprising a processing time parameter.

40. The medium of claim 27, wherein said instructions further cause said processor to:
select a fastest data storage method as said first data storage method; and
establishing a trigger condition comprising a memory space parameter.

42. A system for forming a display list for a print job comprising:
means for storing display list data in memory according to a first data storage method; and,
means for switching from the first data storage method to a second data storage method based on one or more predetermined trigger conditions such that a resulting display list is formed using two or more data storage methods.

43. The system of claim 42, wherein said means for storing display list data further comprise:
means for repeatedly selecting a section of memory for storage of a portion of the display list data;
means for forming a bucket of display list data in the selected section of memory; and
means for logically linking succeeding buckets together to form a series of buckets of display list data.

44. The system of claim 43, further comprising means for recording, in each of the buckets, an indication of the data storage method used to store display list data in that bucket.

45. The system of claim 43, further comprising means for storing, in a bucket, an indication of where, within said bucket, switching from the first to second data storage method occurred.

46. The system of claim 42, further comprising
means for establishing the trigger conditions; and
means for evaluating storage of the display list data for existence of the trigger conditions.
